(19) United States
(12) Patent Application Publication
(10) Pub. No.: US 2007/0230094 A1
(43) Pub. Date: Oct. 4, 2007

(54) Integrated, self-contained power distribution system

(76) Inventor: Curt S. Carlson, Navaree, FL (US)

Correspondence Address: LEV INTELLECTUAL PROPERTY CONSULTING, 4766 MICHIGAN BOULEVARD, YOUNGSTOWN, OH, 44505, US

(21) Appl. No.: 11/731,627

(22) Filed: Mar. 30, 2007

Related U.S. Application Data
(60) Provisional application No. 60/789,081, filed on Apr. 4, 2006.

(51) Int. Cl. H02B 1/26

(52) U.S. Cl. 361/625

(57) ABSTRACT

A portable, temporary power distribution system is contained in a fully integrated, reusable container, and is particularly useful in temporary applications, especially as an alternative power distribution system. The portable system provides comprehensive functionality for all aspects of a power system, and any adjuncts thereto. The portable power distribution system is fully integrated, and can include, for example, low voltage capability, emergency lighting control, communication, power allocation control and circuit protection, as well as any other protective or control feature that is used in a permanent power distribution system for virtually any installation.

### FIELD OF INVENTION

The present invention relates generally to arrangements for service entrance units for temporary power connections. More specifically, the present invention is directed to a safe, repeatable, comprehensive, self-contained, portable/temporary power distribution system.

### BACKGROUND

There are many situations in which temporary or portable power arrangements are essential. The two most prevalent examples of such situations are severe environmental disruptions (such as hurricanes, tornados & fires), and construction or refurbishing projects for existing structures or installations, which have their own power distribution systems (but need temporary power distribution for construction). Other examples include military installations, field hospitals and service & repair facilities for planes & helicopters.

In the first situation a temporary electric power service connection to an auxiliary power source (such as a portable generator) may be necessary to provide power for required applications, at least until the regular sources of power can be restored. Emergency power sources are generally not designed to handle the entire load of the regular power source. Consequently, the available energy has to be carefully allocated to those load circuits which are absolutely necessary, generally emergency lighting, medical machines, special refrigeration units, and the like. In many cases, only emergency circuits are activated. Very often, all system safeguards have been bypassed to do so. Alarms, power metering and allocation systems that are part of the permanent power distribution system will not be activated. Further, such devices are not present in temporary or emergency arrangements that are normally cobbled together with any components that are readily available. The lack of power allocation equipment is particularly problematical since most emergency situations require careful power allocation.

In the second situation the permanent power distribution system of the building or installation is under construction but some power is still needed for a variety of uses before the final connections for the entirety of the permanent power system can been made. Because extensive construction is time-consuming, long-term arrangements are often necessary, even with a temporary power service arrangement. Very often such arrangements are inappropriate for reuse (not repeatable), since they are installed very informally, often with random components, and with virtually no safeguards against weather or other hazards.

In many cases, the amount of temporary power usage is a significant fraction of the normal power expended at a particular location or installation. Very often, the voltage levels for the temporary power are the same as those applied for permanent installations. Accordingly, the same degree of safety and care should be required for temporary power service connections as that required for permanent power installations. Examples of such safety measures are GFI for power receptacles, designated lighting circuits, and emergency power circuits.

Unfortunately a tradition has evolved in the building industry whereby a minimum amount of effort in effecting temporary power service and distribution connection arrangements has become accepted practice. In many cases temporary electrical power service and down stream distribution connections are made using old, often questionable circuit breaker boxes mounted on temporary plywood supports that have been erected in close proximity to the regular connections from the local electrical power system. Very often they are made without adequate protection from the weather or other hazards. Virtually nothing is done with regard to programmed load distribution, alarms or other special functions.

In many temporary power service connection arrangements, everything goes well. This means that there is good weather, proper connections, a serviceable circuit breaker, only limited power use, and no accidents. However, one cannot always count on optimum conditions to avoid the results of questionable temporary power connections, especially in extreme environmental conditions.

For example, in bad weather, a temporary circuit breaker box or similar arrangement may leak, causing a massive short at the main input point. Wet conditions can also lead to multiple fault conditions down line from the circuit breaker box. Very often unprotected lines are attached to various parts of a temporary service box, or the circuit breakers are oversized to avoid nuisance tripping. Any of this can lead to overloaded circuits, and even to fires.

Further, most temporary power distribution arrangements provide only standard house voltage on a few circuits with limited load capacity. Very often, power use on temporary connections will far exceed that originally planned upon. Conventionally, there is very little that can be done to increase capacity once the temporary power service has been energized.

Conventional temporary power service arrangements also do not address situations involving, line monitoring, or programmed power use. Further, there is no provision for alarm systems or any kind of telephone connection related to the control and monitoring of the power system. Also, conventional temporary power service and distribution arrangements do not provide for low voltage applications, such as emergency lighting, or control systems, generator backup sets, closed circuit TV, security circuits for alarms, and rectified 12 volt DC for hazardous duty.

In conventional temporary power distribution arrangements, there is no way to monitor power usage on any more than the main circuit (with a power company meter), so that sources of excessive usage cannot be easily isolated in an extended service area. Conventional temporary arrangements also do not accommodate battery packages necessary for low voltage applications or necessary for uninterruptible power supplies. Nor is there any accommodation for the types of controls such a system would require.

Most temporary power connections are not portable. They are simply cobbled together and nailed to a support in a convenient location. If that location is suddenly found to be inconvenient due to unforeseen conditions, movement of the temporary distribution system could become problematical after activation of the temporary connections. Following standard practice, attempted movement would be either very time-consuming, or very unsafe. All too often, the building industry in the United States tends to follow the latter approach. As a result, many temporary power service connections are questionable at best and disastrous at worst.

Once problems do occur, it is usually impossible to separate sections of the system from each other with conventional temporary power service and distribution arrangements. Consequently, the entire temporary power grid (including both permanent and temporary elements) must be deactivated, rather than just those sections that might be problematical.

Even if a building under construction has a fully completed control, alarm, or power conservation system, these cannot be activated using conventional, temporary power service arrangements. Many of these elements are on special control lines, operating at low voltages. Such voltages are not provided by conventional temporary arrangements. Likewise, there are no provisions with conventional power service arrangements for low voltage emergency lighting, telephone connections, or computer control of any aspect of the system.

An improved temporary power service and distribution system should overcome the major limitations and disadvantages of the conventional art. Such a system would be comprehensive, fully portable, and self-contained. The new system would provide everything that might be necessary from a permanent power distribution system on an “as needed” basis. Such functions would include monitoring, alarm, conservation and general control, as well as all emergency and sectionalizing functions. The improved power service entrance unit would be easily installed and removed for repeated use in various configurations and locations.

### SUMMARY

The primary object of the present invention is to overcome many of the drawbacks of conventional, temporary power service and distribution systems.

Another object of the present invention is to provide a fully comprehensive (integrated) and portable, temporary, power service and distribution system.

A further object of the present invention is to provide an affordable, temporary power service and distribution system that is fully protected for a wide variety of different voltage levels.

It is an additional object of the present invention to provide a temporary, portable power service and distribution system that has a full range of controllable individual circuits.

It is yet another object of the present invention to provide a portable temporary power service and distribution system having timer/control modules to facilitate a wide range of alarm, monitoring and other control functions.

It is yet a further object of the present invention to provide a temporary, portable, power service and distribution system in which individual circuits can be monitored and controlled.

It is again another object of the present invention to provide a temporary, portable power service and distribution system that can accommodate battery connections and arrangements for an uninterruptible power supply.

It is still another object of the present invention to provide a temporary, portable power service and distribution system accommodating telephone connections and other communications/control circuitry.

It is again a further object of the present invention to provide a temporary, portable power service and distribution system that is easily sectionalized into subcircuits or subunits.

It is yet an additional object of the present invention to provide a temporary, portable power service and distribution system that facilitates a repeatable, reusable method of wiring power distribution circuits at different locations.

It is again another object of the present invention to provide a temporary, portable power service and distribution system that facilitates quick installation and removal for reuse.

It is still a further object of the present invention to provide a temporary, portable power service and distribution system that is fully integrated so as to be capable of being installed directly to a power company source to feed an existing load without modification or additional equipment.

It is again an additional object of the present invention provide a temporary, portable power service and distribution system that is physically adaptable to be mechanically supported in a wide variety of different environments.

It is yet another object of the present invention to provide a temporary, portable power service and distribution system that can be constituted by a plurality of interconnected, self-contained units.

It is still a further object of the present invention to provide a temporary, portable power service and distribution system that is fully integrated so as to provide all of the communication/control/protection capability of a permanent power distribution system.

It is yet an additional object of the present invention to provide a temporary, portable power service and distribution system that can be adapted to a wide variety of different configurations, while remaining self-contained.

These and other goals and objects are achieved by an integrated, self-contained power and distribution and service system arranged to serve as a temporary substitute for a permanent power distribution system feeding a distributed electrical load connected to an external power source. The integrated, self-contained power distribution and service system includes at least one self-contained enclosure. Part of the subject system is an input device arranged to connect to an external power source designated to provide power to the distributed electrical power load. Also included is at least one output power distribution circuit allocated for at least part of the distributed electrical power load.

The benefits of the present invention are also manifested by a method of supplying electrical power to a distributed electrical load serviced by a permanent electrical power distribution system. The method includes the steps of bypassing the permanent power distribution system, and then connecting a power source to an integrated, self-contained alternate power service and distribution system. Then, the integrated, self-contained power service and distribution system is connected to at least part of the distributed electrical load.

### DRAWINGS

FIG. 1 is a front interior view of a typical system arranged in accordance with the present invention.

FIG. 2 is a side interior view of the system depicted in FIG. 1.

FIG. 3 is a perspective view of an exterior cabinet arranged for transport and/or deployment.

FIG. 4 is a side view of a timer/control module used in accordance with the present invention.

FIG. 5 is a perspective view of the module depicted in FIG. 5.

### DETAILED DESCRIPTION OF THE PREFERRED EMBODIMENTS

The concept of the present invention is the provision of a substitute, temporary, power service and distribution system for the regular or permanent power distribution system. The temporary or alternate power service and distribution system is connected in parallel to the regular or permanent power distribution system, between the power company source and the actual distributed load being serviced.

The entire substitute or alternative system is contained in an integrated package, providing all of the necessary functions to be found in the permanent power distribution system. The definition of “integrated” as used in this application is a package that contains all the necessary functionality found with a particular permanent power distribution system for which the present invention is substituted.

The container, enclosure or overall package contains everything necessary for a connection to an electrical power source (such as the power company). The integrated package also contains all the necessary equipment to substitute, at least in function for the regular power distribution system. This can include a transformer (or connections to external transformers), and power distribution circuits (including circuit boards and breakers) to substitute for those that normally feed the loads that must be serviced.

Of course, the entire package will be constructed to all necessary codes and standards providing any appropriate safety measures. Since the overall functionality of the fully integrated, substitute electrical service and distribution system is complete, it can be used in similar applications (similar input power levels) and load distributions in different locations. Accordingly, portability is a key feature for the integrated package of the present invention.

It should be understood that in many cases, the load is so elaborate that one variation of the present invention will not have adequate capacity. However, the present invention admits to modularization, and the addition of extended enclosures and packaging. Because a wide variety of voltage levels, load sizes, distribution circuits and control functions can be encompassed by the present invention, a wide variety of different configurations are necessary.

A key aspect of the present invention is that the service and distribution function as well as any other appropriate functionality be contained in an integrated package, as a substitute for an existing (or future) regular power distribution system, so that the existing load can be fed during either construction or time of emergency.

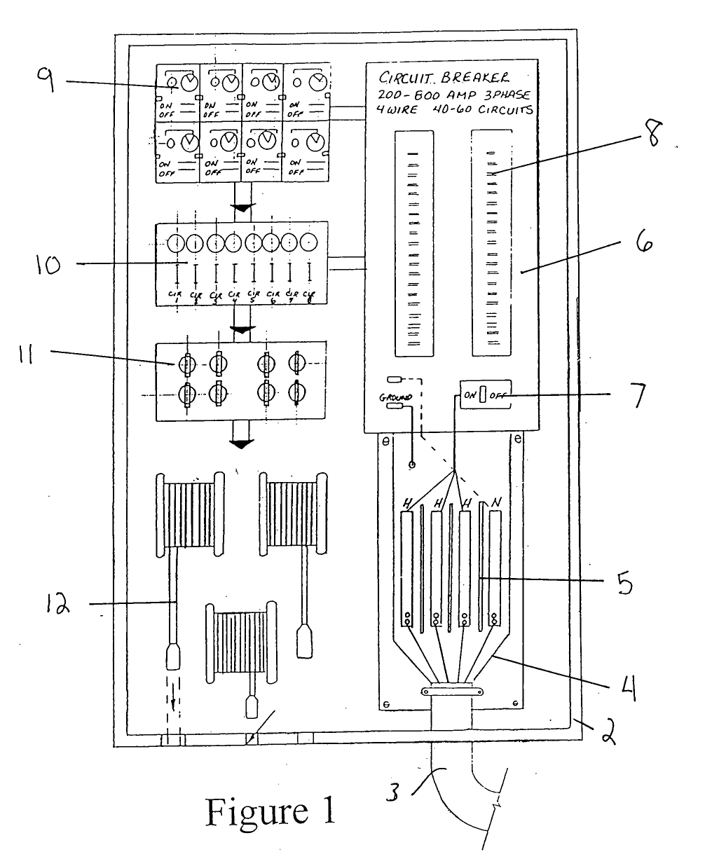

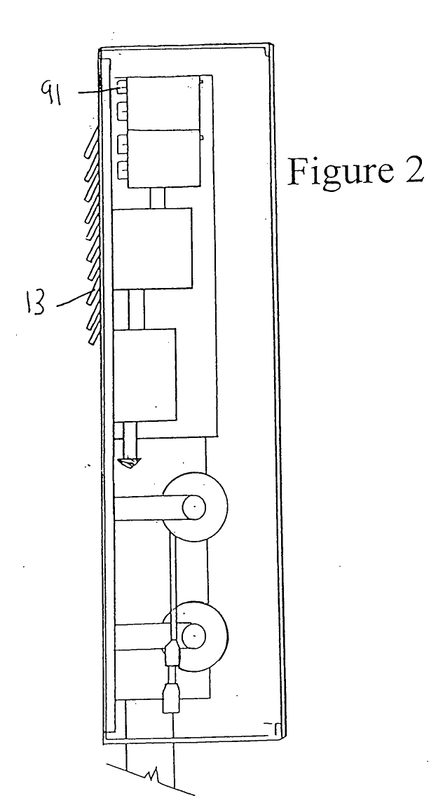

FIG. 1 is a representative arrangement of one embodiment of the present invention. It should be understood that there are many variations, some similar in appearance and others dissimilar in appearance to the arrangements of FIG. 1, which fall within the concept of the present invention. Accordingly, it is expected that a wide range of cabinet shapes and sizes are appropriate for use as part of the present invention. Likewise, a large number of variations are also appropriate, depending upon the power, control, and safety requirements of a particular installation to which the invention is distributing power.

The present invention is meant to provide a safe, repeatable (easily reusable) comprehensive and fully integrated, portable power distribution system in a single weather-proof package. The cabinet 2 (in FIG. 1) contains everything needed for an electrical power service entrance. This includes the hardware to make connection to a power company connection terminal (or other power source). This can, but does not necessarily, include a main switch or breaker, risers or conduits, high voltage stress relief devices, protective devices, and even power transformers.

Likewise, there are accommodations for a variety of secondary circuits, as well as control, monitoring and protection devices, as appropriate for any particular load at an installation being serviced by the present invention. The key is that everything necessary in a permanent installation be provided within cabinet 2, containing the system 1 of the present invention.

For those situations which require sectionalization, multiple cabinets (not shown) can be provided at separating downstream circuit locations. As many cabinets as are needed can be encompassed by the present invention. The cabinets can be equipped as appropriate for each location. It is understood that each cabinet will contain all necessary power distribution equipment for that particular location. Cabinets or enclosures can also be provided with power cable and control links (as well as connection hardware) for connection to other cabinets in the overall distribution system 1.

Everything that would be necessary for a permanent installation (not shown) that the temporary or alternative power system 1 of FIG. 1 is replacing, is to be found in cabinet 2 of the portable power distribution system 1 depicted in FIG. 1. Essentially, the only element of the permanent installation that may not be included in the FIG. 1 arrangement is the total power-carrying capacity that would be found in a permanent power distribution system. This can include all subcircuits, monitoring arrangements, emergency systems, control schemes, alarm schemes and any necessary circuits to support them. This could also include any circuits for a 480 volt, three phase welding bus, circuits for construction elevators, lift stations and construction cranes. Also included could be optical control circuitry, or control circuitry used for receiving control signals over a telephone line. Because of the comprehensive nature of the present invention, it is especially effective in situations where temporary power systems are needed. In effect, the present invention acts as a substitute for a complete permanent installation while the present invention is in use.

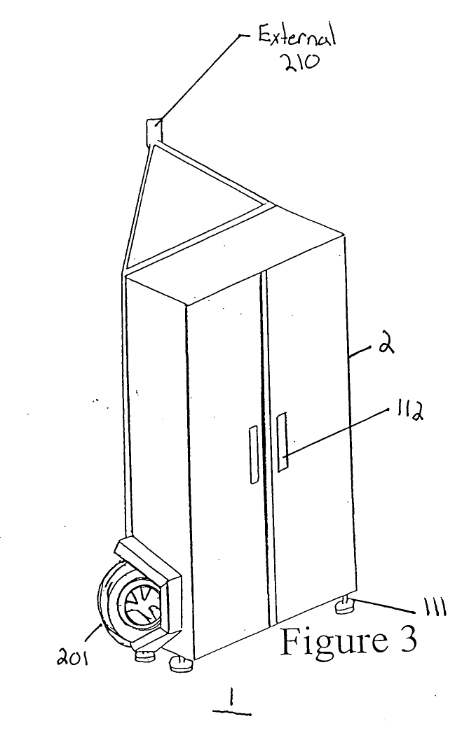

FIG. 1 depicts a front view of a main power input and control arrangement of the inventive portable power distribution system 1. The entire input and control arrangement is contained in a single waterproof cabinet 2. Preferably, cabinet 2 is built so that it can be put on rollers or some other device facilitating portability. One example of means for effecting portability is depicted in FIG. 3. The wheels 201 can be built into cabinet 2, and can be removable if desired. In the alternative, the wheels can be provided by a simple (permanent or removable) dolly. A key attribute is that the cabinet be portable, by whatever means is convenient. Levelers 111 can be used in conjunction with permanent wheels (or casters) 201 to provide a stable mounting arrangement.

It should be understood that cabinet 2 can be formed in any number of sizes and shapes, depending upon the equipment contained therein. Accordingly, any number of different transport means can be used. For example a hitch, such as that depicted in FIG. 3, can be used with a crane or other appropriate vehicle. Small cabinets can be moved on dollies or by hand. During transport, cabinet doors 112 can be secured using appropriate latching mechanisms.

The main power input from a power company or other power source is provided through the bottom of cabinet or housing 2 through conduit or pipe 3. Preferably, this pipe-like structure is 3½ to 6 inches in diameter. It can be fed through the top of housing or cabinet 2 as well as the bottom to accommodate underground or overhead services. The cabinet has the necessary mechanical structure to accommodate a conduit being fed either through the bottom or the top of the conduit. In some cases, a conduit (not shown) extends from the top of the cabinet and ends in a device appropriate for connection to a high voltage termination.

Once inside of cabinet 2, the high voltage cable leaves conduit 3, is divided and connected to main bus bars 5. The arrangement depicted in FIG. 1 includes a 480 volt, three-phase arrangement. However, single phase arrangements can also be used within the concept of the present invention. While the arrangement depicted for FIG. 1 is a three phase 480 volt class installation, a variety of other voltage levels can be used, as appropriate. However, higher voltage levels will require larger bus and insulators, necessitating the use of larger cabinets, stress relief devices, and other increased safety measures.

An important attribute of the present invention is that it be comprehensive or fully integrated, containing all necessary elements to make a connection with the available power sources. Necessary connection means can be anything from terminal lugs arranged on bus bars, conduit extensions and connectors, and even stress relief devices. Everything for a temporary or permanent connection to a power source is contained with an enclosure to the present invention.

Even if the permanent installation does not normally use 480 volt three phase power, the provision of this capability can be very useful for such construction applications as welding. Thus, the welding bus 11 in the configuration of FIG. 1 serves a useful purpose in a temporary power distribution system, even if 480 volt welding power is not necessary in the permanent installation. In this way, utility arrangements (such as a welding bus) can be provided via a temporary power of distribution system 1, without the expense of providing the same resources for the permanent instillation.

The subsidiary circuit breakers 8 on circuit board 6 operate at the input voltage (480 volts for this example), and can be used to feed a number of loads, such as those that exist in the permanent installation being fed by the temporary, portable power distribution system 1. Circuit board 6 operates (feeding loads) in the same manner as a conventional circuit breaker box in a permanent electrical distribution system for the installation being serviced.

While many of the loads in the permanent installation can be fed, either directly or indirectly, by the circuit breakers in circuit board 6, there are limitations with any temporary arrangement. It is very difficult for the number of subsidiary circuits in a temporary arrangement to match that in a permanent installation. However, one of the benefits of the present invention is that cabinets or housings 2 can be configured for additional circuit boards 6 in order to feed a greater number of loads. This capacity is limited only by the additional size and weight necessitated by the extra capacity of the portable power distribution system 1.

The power demands of the installation being serviced may extend to far more than power for lights and appliances. For example, there may be substantial power allocated to heating and cooling systems, for both air and water. There may also be substantial power allocated for operating rotating machines, such as those found in maintenance or repair shops. Consequently, there may be any number of circuits operating at higher voltages and current consumption levels than are required for standard lighting circuits. These have to be accommodated to some extent by the temporary power distribution system 1, as well as completely by the permanent power distribution system (not shown).

Very often individual circuits must be monitored to keep track of specific power use. Well-known means for monitoring and even controlling power usage for specific circuits are common in permanent power distribution installations. However, conventional temporary power distribution systems do not accommodate this functionality. It is one major improvement of the present invention to provide monitoring and control devices for selected, individual circuits. This functionality is provided through timer/control modules 9. These modules are microprocessor-based, and can also be configured in any manner that allow them to carry out a wide variety of monitoring and control functions in the inventive temporary distribution system 1. These modules can be of any type commercially available, or custom-designed.

Besides controlling the timing of selected circuits, the modules 9 can feed monitoring means (not shown), and provide any other circuit control or protection functions considered desirable. These could include additional circuit protection means for specific applications, such as under voltage or over voltage conditions, as well as specially configured ground fault settings.

Temporary power distribution system 1 can include batteries (not shown) for purposes of providing emergency low voltage (D.C.) power for lighting. The modules 9 can be further configured so that the functions of an uninterruptible power supply (using an external generator) are combined using batteries that can be stored in cabinet 2 or external to it. The uninterruptible power supply, using an external generator, can provide power to selected circuits or breakers 8 as determined by the control modules 9. One control module 9 can be used to feed several switches 10 to individual circuits.

Some of these circuits could be in the form of extension cords or cables 12. These can be deployed to support temporary work that is done close to cabinet 2 without incurring the expense of running additional circuits from connectors 13 on the rear of cabinet 2. It is conceivable that a sufficient number of extension cords 12 can be contained within cabinet 2 to supply all of the circuits for all of the breakers 8 and switches 10 contained within the portable power distribution system 1. These cords could be extended to directly feed selected loads, thereby bypassing feeder circuits in the permanent installation. This arrangement allows for work to be done on the feeder cables of the permanent installation while still servicing the loads that are normally serviced by those permanent feeder circuits. In effect, the temporary portable power system 1, substitutes entirely for the permanent power distribution system servicing a particular installation. Under the concept of the present invention, it is possible that an entire permanent power distribution system can be simulated by temporary circuits contained in temporary portable power distribution system 1.

Each of the connectors 13 corresponds to the output of one of the breakers 8 of circuit board 6, or one of the switches 10 (which can be fed by the breakers or arranged parallel to them). Some of the connectors 13 can also be dedicated to low voltage circuits, high voltage welding circuits (from bus board 11), lighting circuits from switch board 10, low voltage and control circuitry from the timer/control modules 9. Of course the connectors 13 will be configured based upon the voltage level and the size of the load to be serviced.

Batteries (not shown) can be part of the low voltage lighting arrangements controlled by timer/control modules 9. These can be used to power low voltage emergency lighting circuits & exit lights. The batteries can be mounted where convenient in the cabinet 2. The mounting means and location will be determined by the size of the batteries. Auxiliary battery compartments can be mounted on cabinet 2, depending upon the size of the batteries and the necessary equipment contained in cabinet 2. Certain types of batteries must be mounted in separate housings, however, such housings can be arranged as part of an integral unit with cabinet 2.

It should be understood that power outlets or connectors 13 from cabinet 2 can be placed on the rear, top, sides or bottom of cabinet 2. The placement of apertures (to accommodate connectors 13 and cables) on the cabinet will be determined by the environment in which the cabinet is placed. The cabinet and connectors 13 can be configured to its specific environment, providing weatherproof (including rain proof and splash proof) capabilities. If cabinet 2 is placed in a more stressful environment, gas resistant, earthquake resistant and/or explosion resistant capabilities can be built into cabinet 2. Such capabilities would also dictate the type of input and output connections that can be made. Such capabilities are well-known for permanent power distribution systems. With temporary power distribution system 1 having the necessary environmental attributes, power can be provided in environments that would not permit the deployment of conventional temporary power distribution equipment. Thus, one benefit of the present invention is that in many environments, electrical power service can be provided much sooner than would otherwise be the case.

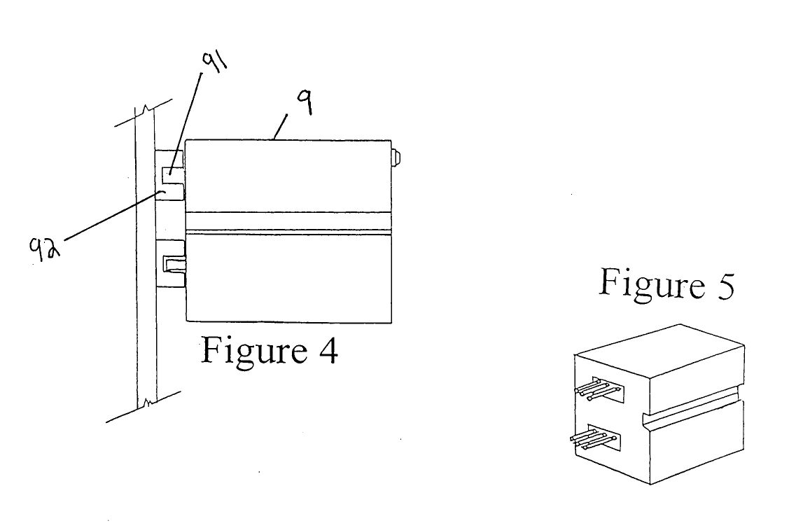

Timer/control modules 9 are an important aspect of the inventive system 1, at least for the more complex control and programming operations, such as alarm and monitoring. To facilitate interchangeability and effectiveness of modules 9, the connection arrangement of FIG. 4 can be used. Connection prongs 91, are used on each of the modules 9, and interface with connection bus 92. As depicted, a three-pronged male contact is used for modules controlling as emergency lighting applications. The bus 92, generally accommodates a three-pronged male contact point with two circuits and a neutral. However, different connection arrangements can be used if so desired. Further, while a slide-in module 9, is used in the arrangement of FIG. 4, different connection arrangements can be included. Also, while a rectangular module has been employed, is also possible to use other shapes for the removable timer/control modules 9.

Step-down transformers (or in rare cases step-up transformers) are very often necessary for power distribution systems. For example, 480 volt input needs to be stepped down in order to provide standard lighting voltage levels. When the total power levels involved are sufficiently small, the transformer can be contained in housing or cabinet 2. In other cases, the transformer would be integrally attached to the power distribution housing 2, but contained within its own, separate housing. Such an arrangement is usually suitable only when dry-type, air-cooled transformers are employed. Liquid cooled transformers generally have to be placed within their own mounting arrangements, which exclude the placement of distribution systems switch gear. These can be incorporated as an integral package of cabinets.

Preferably, cabinet 2, is arranged so that it can be easily transported. To facilitate this, built-in structures such as hitch 200, and wheels 201 (depicted in FIG. 3) can be provided. These can be arranged to be removed and/or bolted on to fork like structures (not shown) that fold down from the rear of cabinet 2, so as to provide added stabilization. All of these structures can be manufactured as part of the cabinet, or added afterwards to facilitate placement of the cabinet. Load levelers 111, can also be provided to facilitate installation. These transport and installation devices are helpful but not necessary for the practice of the present invention. Rather, it is only necessary that the temporary, portable power system 1, be contained within housings that can be transported.

Very often, the portable power distribution system 1, is in such a large housing 2, that it can only be transported through the aid of a crane or a forklift. Other variations can be transported using standard baggage trucks or small transport vehicles. It should be remembered that the size of cabinet 2, can be made appropriate for the size of the system 1, to be contained therein. Likewise, the size of the power distribution system is determined by the temporary load of the installation being serviced.

Entry and exit of telephone lines and alarm sensors can be made to cabinet 2, at any point appropriate for making connections to timer/control modules 9, while maintaining the integrity of the cabinet. Provisions to maintain weather proof integrity for connections through the sides of cabinet 2, can be made as considered appropriate for the on-site environment.

It should be clear to one skilled in this art, that portable power distribution system 1 can be arranged in a variety of different sizes, with appropriate housing 2, sizes. Because the breakers 8, in circuit board 6, admit to a large variety of different sizes and capacities, large subsidiary circuits can be fed, preferably using connectors 13, on the rear of cabinet 2. If these subsidiary circuits are large enough, they can feed smaller subsidiary distribution systems in smaller, independent cabinet (not shown). Subsidiary power distribution systems 1, can be placed on separate floors of buildings that are being fed by the main temporary portable power distribution system 1, at the input from the power company. The subsidiary temporary power distribution systems can also include their own transformers for stepped down voltages. These can be stored within the cabinet along side or in place of batteries, as previously discussed. These secondary cabinets would serve as substations for the service entrance portable power distribution system 1 of FIG. 1.

It should be understood that the power connections from the temporary power distribution system 1, can be fed to various points in the permanent distribution system, or into a parallel, temporary set of circuits. The choice would be based upon the ongoing construction, the nature of the permanent circuitry and time-sensitive demands for power, at the installation. The present invention would allow selected deactivation of various parts of the installation, when work on each part would be required. This could be done in a systematic and highly controlled manner consistent with both safety and power conservation. The present invention would permit complete, comprehensive control over both temporary circuits and the activated, permanent parts of the installation.

The present invention permits quick installation of a temporary power distribution system, as well as quick removal. Prearranged connection schemes, both input and output both allow power to be fed to the load to be serviced very quickly. This is an essential benefit when dealing with the emergency situations, or even building projects when trying to save time.

While a number of embodiments have been presented by way of example, the present invention is not limited thereto. Rather, the present invention should be construed to include any and all variations, permutations, adaptations, derivations and embodiments that might occur to both users and designers of temporary power distribution systems. Accordingly, the present invention should be limited only by the following claims.

I claim:

1. An integrated, self-contained power distribution and service system arranged to serve as a temporary substitute for a permanent power distribution system feeding a distributed electrical power load connected to an external power source, said integrated, self-contained power distribution and service system includes at least one self-contained enclosure, integrating:
(a) an input device arranged to connect to an external power source designated to provide power to said distributed electrical power load; and
(b) at least one output power distribution circuit allocated for at least part of said distributed electrical power load.

2. The integrated, self-contained power distribution and service system of claim 1, further comprising:
(c) control means for allocating electrical power in said at least one output power distribution circuit.

3. The integrated, self-contained power distribution and service system of claim 1, wherein said at least one enclosure is weather proof.

4. The integrated, self-contained power distribution and service system of claim 1, wherein said self-contained enclosure is portable.

5. The integrated, self-contained power distribution and service system of claim 2, wherein said input device comprises high voltage, stress-relief connections.

6. The integrated, self-contained power distribution and service system of claim 4, wherein said at least one enclosure comprises devices to effect portability.

7. The integrated, self-contained power distribution and service system of claim 1, wherein said at least one output power distribution circuit comprises at least one protective device.

8. The integrated, self-contained power distribution and service system of claim 5, further comprising a transformer.

9. The integrated, self-contained power distribution and service system of claim 5, further comprising a high-voltage output arrangement and a low voltage input arrangement.

10. The integrated, self-contained power distribution and service system of claim 3, further comprising a battery.

11. The integrated, self-contained power distribution and service system of claim 10, further comprising an emergency switching system.

12. The integrated, self-contained power distribution and service system of claim 11, further comprising an uninterruptible power switching system.

13. The integrated, self-contained power distribution and service system of claim 2, further comprising telephone connections.

14. The integrated, self-contained power distribution and service system of claim 13, further comprising an alarm system arranged to service said distributed electrical power load and said permanent power distribution system.

15. The integrated, self-contained power distribution and service system of claim 14, further comprising power measuring and allocation system for servicing said distributed electrical power load.

16. The integrated, self-contained power distribution and service system of claim 11, further comprising and emergency lighting control system for servicing and installation serviced by said permanent power distribution system.

17. The integrated, self-contained power distribution and service system of claim 6, wherein said devices to effect portability are selected from a group consisting of: casters, wheels, channels for receiving forklift blades, crane attachments, and folding forklift blades.

18. The integrated, self-contained power distribution and service system of claim 7, wherein said protective device is comprised of at least one ground fault protection system.

19. A method of supplying power to a distributed electrical power load serviced by a permanent electrical power distribution system, said method comprising the steps of:
a) bypassing said permanent power distribution system;
b) connecting a power source arranged to feed said permanent power distribution system to an integrated, self-contained alternate power and service distribution system; and
c) connecting said integrated, self-contained power service and distribution system to at least part of said distributed electrical power load.
